(19) United States
(12) Patent Application Publication
(10) Pub. No.: US 2020/0322692 A1
(43) Pub. Date: Oct. 8, 2020

(54) PROXY DEVICE, PROCESSING METHOD OF PROXY DEVICE, AND NETWORK APPARATUS

(71) Applicant: SONY CORPORATION

(72) Inventors: SATOSHI MIYAZAKI, KANAGAWA (JP); GEN ICHIMURA, TOKYO (JP); KAZUAKI TOBA, KANAGAWA (JP); KAZUO YAMAMOTO, CHIBA (JP)

(21) Appl. No.: 16/305,889

(22) PCT Filed: Jun. 6, 2017
(86) PCT No.: PCT/JP2017/021035

§ 371 Date: Nov. 29, 2018

(30) Foreign Application Priority Data
Jun. 13, 2016 (JP) 2016-117446

(51) Int. Cl. H04N 21/643; H04N 21/222; H04N 21/4363

(52) U.S. Cl. CPC H04N 21/64322; H04N 21/43635; H04N 21/222

(57) ABSTRACT

It is possible to preferably transmit a command received from an external network to a corresponding device in an internal network. A command transmitted from a device on a first network is received. Transmitter information and receiver information are added to the received command, and the command is sent to a command transmission path of a second network. The transmitter information added to the command is rewritten from information regarding a proxy device to information regarding a device capable of transmitting the command when the proxy device is a device incapable of transmitting the received command.

### CITATION LIST

### Patent Literature

[PTL 1]
US 2013/0014184 A1

### SUMMARY

### Technical Problem

In a CEC, a concept of a device type is present, and there is a command which can be transmitted by only a device of a particular device type. For example, a command <Record TV Screen> is assumed to be transmitted by a “Recording Device.” It is recommended that, when the command <Record TV Screen> is transmitted from other than the “Recording Device,” a “TV” neglects this command.

For convenience of a user, as in the proxy device, it is preferred that one main controller can be set within the HDMI network. However, since a device-dependent command is present in the CEC, it is difficult to control all devices within the network from the main controller.

An object of the present technology is to preferably allow a command received from an external network to be transmitted to a corresponding device in an internal network.

### Solution to Problem

A concept of the present technology is a proxy device including a command reception section receiving a command transmitted from a device on a first network, and a command sending section adding transmitter information and receiver information to the received command and sending the command to a command transmission path of a second network. The command sending section rewrites the transmitter information added to the command from information regarding the proxy device to information regarding a device capable of transmitting the command when the proxy device is a device incapable of transmitting the received command.

In the present technology, by the command reception section, a command transmitted from a device on the first network is received. By the command sending section, transmitter information and receiver information are added to the received command and the command is sent to the command transmission path of the second network. In the command sending section, the transmitter information added to the command is rewritten from information regarding a proxy device to information regarding a device capable of transmitting the command when the proxy device is a device incapable of transmitting the received command.

For example, the proxy device may further include a database in which a command is made to correspond to a device capable of transmitting the command, and the command sending section may obtain information regarding a device capable of transmitting the received command on the basis of the database. Further, for example, the first network may be an IP network, the second network may be an HDMI network, and the command transmission path may be a CEC bus.

In the present technology described above, when the proxy device is a device incapable of transmitting the received command, the command sending section rewrites the transmitter information added to the command from information regarding the proxy device to information regarding a device capable of transmitting the command. Therefore, a command received from an external network can be preferably transmitted to a corresponding device in an internal network.

Note that, in the present technology, for example, the proxy device may further include a response determination section determining a response sent corresponding to the command to the command transmission path to be a response to the proxy device on the basis of the rewritten transmitter information when the rewrite of the transmitter information is performed by the command sending section. In this case, even if the rewrite of the transmitter information is performed, it can be appropriately determined that the response corresponding to the command is given.

Another concept of the present technology is a network apparatus including a plurality of devices that are connected to one another. At least one device of the plurality of devices has a proxy function. The device having the proxy function includes a command reception section receiving a command transmitted from a device on an external network, and a command sending section adding transmitter information and receiver information to the received command and sending the command to a command transmission path. The command sending section rewrites the transmitter information added to the command from information regarding the device having the proxy function to information regarding a device capable of transmitting the command when the device having the proxy function is a device incapable of transmitting the received command.

In the present technology, a network apparatus includes a plurality of devices that are connected to one another. At least one device of the plurality of devices has a proxy function. In the device having the proxy function, a command reception section and a command sending section are included. By the command reception section, a command transmitted from the device on an external network is received.

By the command sending section, transmitter information and receiver information are added to the received command, and the command is sent to the command transmission path. By the command sending section, the transmitter information added to the command is rewritten from information regarding the proxy device having the proxy function to information regarding a device capable of transmitting the command when the device having the proxy function is a device incapable of transmitting the received command.

In the present technology described above, the device having the proxy function rewrites the transmitter information added to the command from its own information to information regarding the device capable of transmitting the command when the device having the proxy function is a device incapable of transmitting the received command. Therefore, the device having the proxy function can preferably transmit the command received from the external network to the corresponding device in the internal network.

### Advantageous Effect of Invention

According to the present technology, it is possible to preferably transmit a command received from an external network to a corresponding device in an internal network. Note that the effect described in the present specification is merely illustrative and is not limitative, and additional effects may be obtained.

### BRIEF DESCRIPTION OF DRAWINGS

FIG. 1 is a block diagram illustrating a configuration example of a home network system according to an embodiment.

FIG. 2 is a diagram schematically illustrating an interface configuration of each device in an HDMI network 20.

FIG. 3 is a flowchart illustrating an example of processing of an AV amplifier in sending a command transmitted from a control point to a CEC bus.

FIG. 4 is a flowchart illustrating an example of the processing of the AV amplifier in confirming a response to an impersonated device and then receiving the above response as a response to the AV amplifier.

FIG. 5 is a diagram illustrating an example of commands in which a device capable of transmitting each of the commands is determined.

FIG. 6 is a diagram illustrating a header block of a CEC frame in which a command transmitted from the control point to the AV amplifier is <Record TV Screen> or a command equivalent to this command, in a normal case and in a case where impersonation is performed.

FIG. 7 is a sequence diagram in a case where the command of <Record TV Screen> or a command equivalent to this command is transmitted from the control point to the AV amplifier.

FIG. 8 is a diagram illustrating a header block of a CEC frame in which a command transmitted from the control point to the AV amplifier is <Record On> or a command equivalent to this command, in a normal case and in a case where impersonation is performed.

FIG. 9 is a sequence diagram in a case where the command of <Record On> or a command equivalent to this command is transmitted from the control point to the AV amplifier.

### DESCRIPTION OF EMBODIMENTS

Hereinafter, a mode (hereinafter, referred to as an embodiment) for carrying out the present invention will be described. Note that descriptions will be made in the following order.

1. Embodiment

2. Modification Example

### 1. Embodiment

### Configuration Example of Home Network

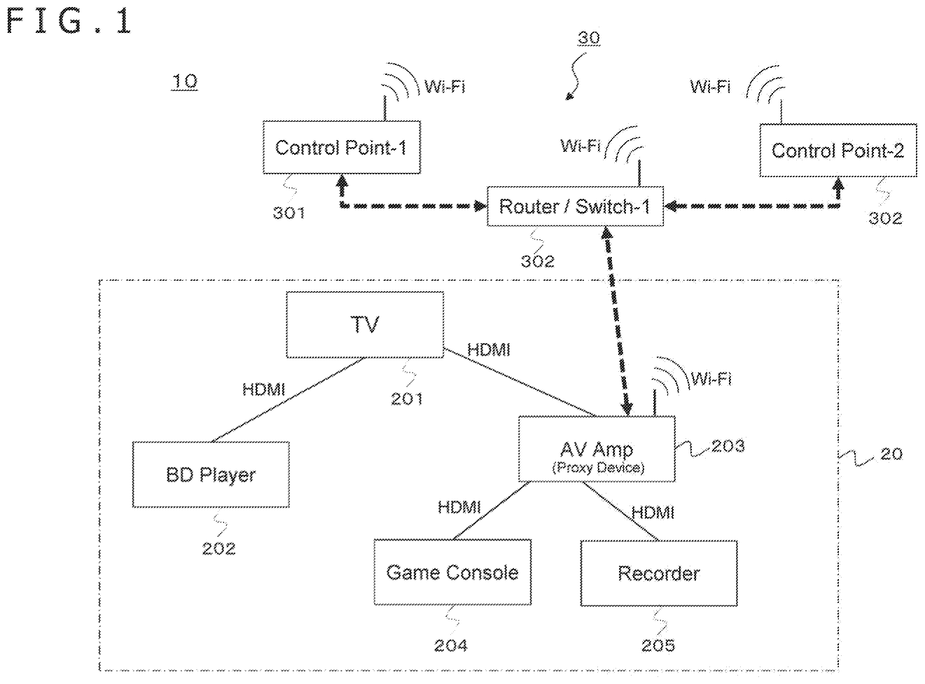

FIG. 1 illustrates a configuration example of a home network system 10 according to an embodiment. In the home network system 10, an HDMI network 20 and an IP network 30 are included.

The HDMI network 20 is configured such that a television receiver (TV) 201 as a sink device, a BD player 202 as a source device, an AV amplifier (AV Amp) 203 as a repeater device, a game console 204 as a source device, and a recorder 205 as a source device are connected through an HDMI cable.

In this case, the BD player 202 and the AV amplifier 203 are connected to the television receiver 201. Further, the game console 204 and the recorder 205 are connected to the AV amplifier 203. Here, the AV amplifier 203 constitutes a device having a proxy function, that is, a proxy device serving as a main controller of the HDMI network 20.

The IP network 30 is configured such that a control point (Control Point-1) 301, a control point (Control Point-2) 302, a router/switch 303, and the AV amplifier 203 are wirelessly connected by using a WiFi (Wireless Fidelity) system. Specifically, the control points 301 and 302 are, for example, portable terminals such as a smartphone or a tablet.

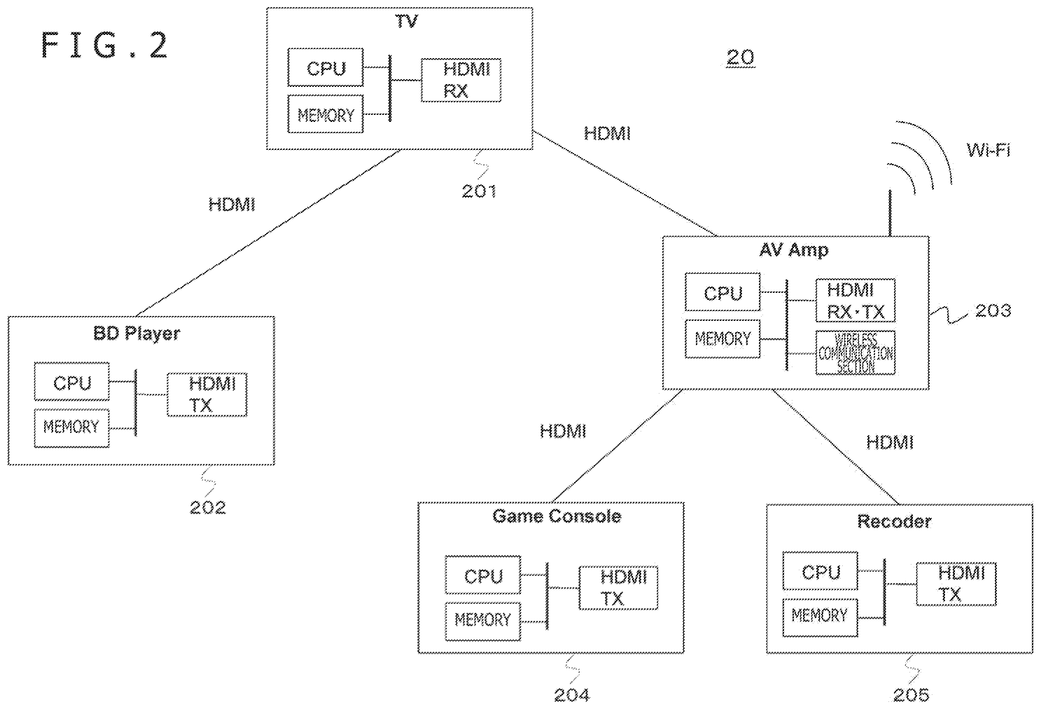

FIG. 2 schematically illustrates an interface configuration of each device in the HDMI network 20. The television receiver 201 includes a CPU for controlling the entire operation, a memory such as a ROM and a RAM, an HDMI reception section (HDMI RX), and the like. Further, the BD player 202 includes a CPU for controlling the entire operation, a memory such as a ROM and a RAM, an HDMI transmission section (HDMI TX), and the like.

Further, the AV amplifier 203 includes a CPU for controlling the entire operation, a memory such as a ROM and a RAM, an HDMI reception section (HDMI RX), an HDMI transmission section (HDMI TX), a wireless communication section that performs wireless communication in accordance with the WiFi system, and the like. Further, each of the game console 204 and the recorder 205 includes a CPU for controlling the entire operation, a memory such as a ROM and a RAM, the HDMI transmission section (HDMI TX), and the like.

In the home network system 10 illustrated in FIG. 1, the user operates the control point 301 or the control point 302 to thereby control each device in the HDMI network 20. In this case, the control point transmits an IP command (an IP packet containing a command in a payload) to the AV amplifier 203. The AV amplifier 203 converts the IP command into a CEC command (CEC frame containing a command in a data block) and sends the CEC command to a CEC bus (CEC line).

Here, in a header block of the CEC frame, a transmitter address as transmitter information and a receiver address as receiver information are arranged. When the AV amplifier 203 cannot transmit a command transmitted from the control point by itself, the AV amplifier 203 generates a CEC command in which the transmitter address is rewritten from its own address to an address of a device capable of transmitting the command, that is, an impersonated CEC command and sends the CEC command to the CEC bus.

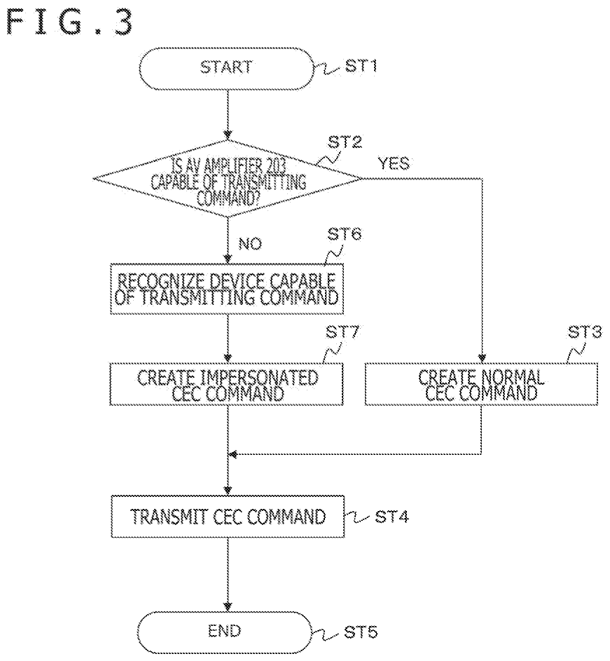

A flowchart illustrated in FIG. 3 illustrates an example of processing of the AV amplifier 203 in sending a command transmitted from the control point to the CEC bus. At step ST1, the AV amplifier 203 starts the processing. Then, at step ST2, the AV amplifier 203 determines whether the AV amplifier 203 can transmit the command by itself.

When it is determined that the AV amplifier 203 can transmit the command by itself, at step ST3, the AV amplifier 203 creates a normal CEC command, specifically, a CEC command in which the transmitter address is set as its own address. At step ST4, the AV amplifier 203 transmits the created CEC command, specifically, sends the CEC command to the CEC bus. Then, at step ST5, the processing ends.

Alternatively, when it is determined that the AV amplifier 203 cannot transmit the command by itself, at step ST6, the AV amplifier 203 recognizes a device capable of transmitting the command. The AV amplifier 203 includes a database in which the command is made to correspond to the device capable of transmitting this command, in the memory. The AV amplifier 203 recognizes the device capable of transmitting the command on the basis of this database.

Next, at step ST7, the AV amplifier 203 creates an impersonated CEC command, specifically, a CEC command in which the transmitter address is rewritten from its own address to an address of the device capable of transmitting the command. Then, at step ST4, the AV amplifier 203 transmits the created CEC command, specifically, sends the CEC command to the CEC bus. Then, at step ST5, the processing ends.

Further, when the impersonated CEC command is sent to the CEC bus, the AV amplifier 203 monitors a signal flowing in the CEC bus, so that the AV amplifier 203 confirms a response to the impersonated device that is sent corresponding to the impersonated CEC command and receives the above response as a response to the AV amplifier 203.

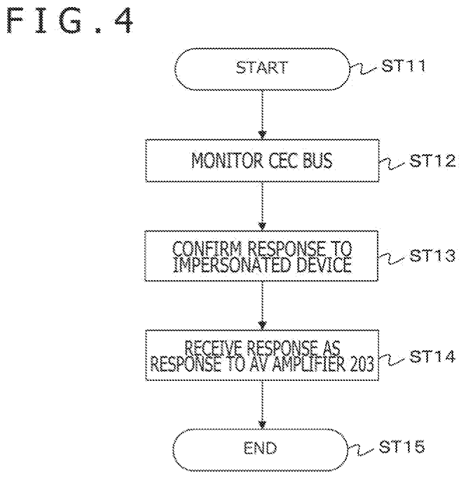

A flowchart illustrated in FIG. 4 illustrates an example of the processing of the AV amplifier 203 when the AV amplifier 203 confirms the response to the impersonated device and receives the above response as the response to the AV amplifier 203. At step ST11, the AV amplifier 203 starts the processing. Then, at step ST12, the AV amplifier 203 monitors the CEC bus (CEC line).

Then, at step ST13, the AV amplifier 203 confirms the response to the impersonated device, and at step ST 14, the AV amplifier 203 receives the above response as the response to the AV amplifier 203. Then, at step ST15, the AV amplifier 203 ends the processing.

Note that, when the AV amplifier 203 performs a command transmission and a response reception through the impersonation, the impersonated device itself does not get involved in a transaction thereof. Therefore, the impersonated device suddenly receives a response that is not concerned with itself. In this case, when an unmeaningful response is delivered, the impersonated device neglects the response.

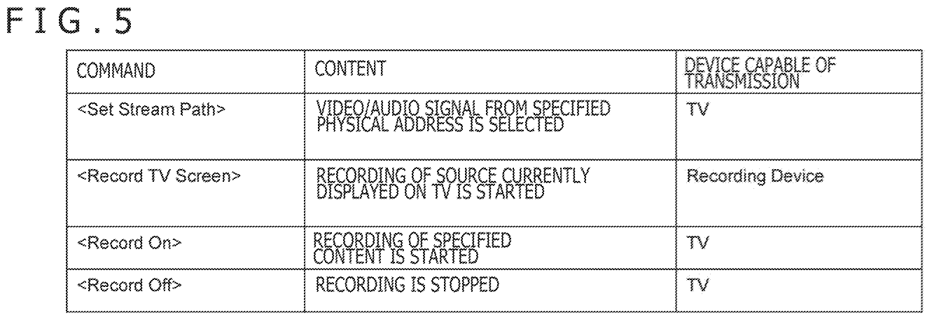

FIG. 5 illustrates an example of commands in which a device capable of transmitting each of the commands is determined. A command <Set Stream Path> is a command in which the device capable of transmitting the command is “TV” and a video/audio signal from a specified physical address is selected. A command <Record TV Screen> is a command in which the device capable of transmitting the command is “Recording Device” and recording of a source currently displayed on “TV” is started. A command <Record On> is a command in which the device capable of transmitting the command is “TV” and the recording of the specified content is started. A command <Record Off> is a command in which the device capable of transmitting the command is “TV” and the recording is stopped.

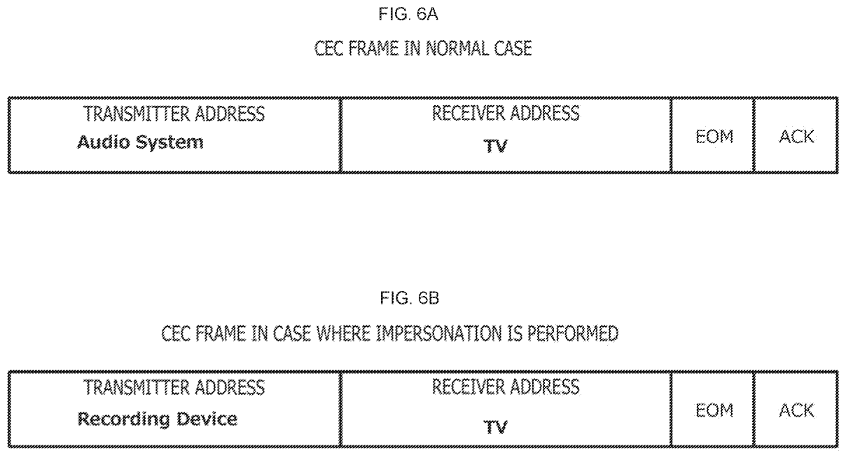

FIG. 6(a) illustrates a header block of a CEC frame that is normally created in the AV amplifier 203, specifically, and in which rewrite of the transmitter address is not performed in a case where a command transmitted from the control point to the AV amplifier 203 is <Record TV Screen> or a command equivalent to this command. In this case, the transmitter address is “Audio System” that is its own address, and the receiver address is “TV.”

However, the device capable of transmitting the command of <Record TV Screen> is “Recording Device” as illustrated in FIG. 5. Therefore, as illustrated in FIG. 6(b), the AV amplifier 203 generates a CEC frame in which the transmitter address is rewritten to the “Recording Device” that is an address of the device capable of transmitting the command of “Record TV Screen,” that is, a CEC frame in which the impersonation is performed, and sends the CEC frame to the CEC bus (CEC line).

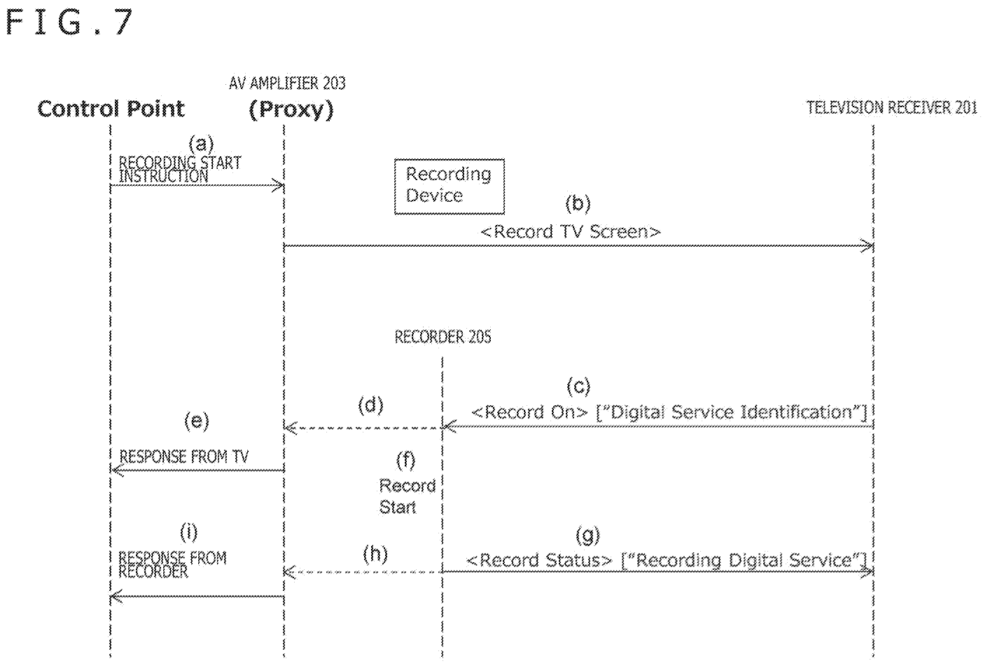

FIG. 7 illustrates a sequence diagram in a case where a start operation of the recording of a source currently displayed on the television receiver 201 is performed by the user and the command of <Record TV Screen> or a command equivalent to this command is transmitted from the control point to the AV amplifier 203.

(a) The control point transmits the command of <Record TV Screen> or the command corresponding to this command to the AV amplifier 203 and instructs the recording of the source currently displayed on the television receiver 201 to be started.

(a) The AV amplifier 203 transmits a CEC frame containing the command of <Record TV Screen> to the television receiver 201 through the CEC bus. In this case, the AV amplifier 203 is not the device capable of transmitting the command of <Record TV Screen> and generates a CEC frame (impersonated CEC frame) in which the transmitter address is rewritten to “Recording Device” that is an address of the device capable of transmitting the command of <Record TV Screen>, and the AV amplifier 203 transmits the rewritten CEC frame (see FIG. 6(b)).

(c) The television receiver 201 that receives the CEC frame containing the command of <Record TV Screen> transmits as a response a CEC frame containing, as a message, reception channel information (identification information regarding digital service) of the currently displayed source to the recorder 205 that is “Recording Device” through the CEC bus.

(d) In this case, the AV amplifier 203 monitors the CEC bus, confirms the response from the television receiver 201 to the recorder 205 and receives the above response as the response to the AV amplifier 203. (e) Further, the AV amplifier 203 transmits information regarding the response to the control point. The control point can display a receiving channel of the television receiver 201 on a display on the basis of the information.

(f) The recorder 205 that receives the CEC frame as a response from the television receiver 201 makes a receiving channel of a tuner the same as that of the television receiver 201 on the basis of the receiving channel information and starts recording. (g) Further, the recorder 205 transmits as a response a CEC frame containing recording status information to the television receiver 201 through the CEC bus.

(h) In this case, the AV amplifier 203 monitors the CEC bus, confirms the response from the recorder 205 to the television receiver 201, and receives the above response as the response to the AV amplifier 203. (i) Further, the AV amplifier 203 transmits the information regarding the response to the control point. The control point can display a start of the recording on the display on the basis of the information.

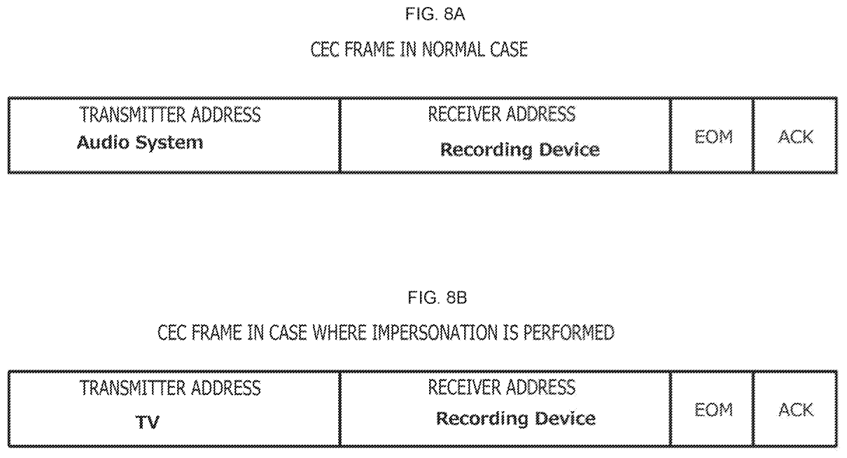

FIG. 8(a) illustrates a header block of a CEC frame that is normally created in the AV amplifier 203, specifically, in which the rewrite of the transmitter address is not performed in a case where the command transmitted from the control point to the AV amplifier 203 is a command of <Record On> or a command equivalent to this command. In this case, the transmitter address is “Audio System” that is its own address, and the receiver address is “Recording Device.”

However, the device capable of transmitting the command of <Record On> is “TV” as illustrated in FIG. 5. Therefore, the AV amplifier 203 generates a CEC frame in which the transmitter address is rewritten to “TV” that is an address of the device capable of transmitting the command of <Record On> as illustrated in FIG. 8(b), that is, a CEC frame in which the impersonation is performed, and the AV amplifier 203 sends the rewritten CEC frame to the CEC bus (CEC line).

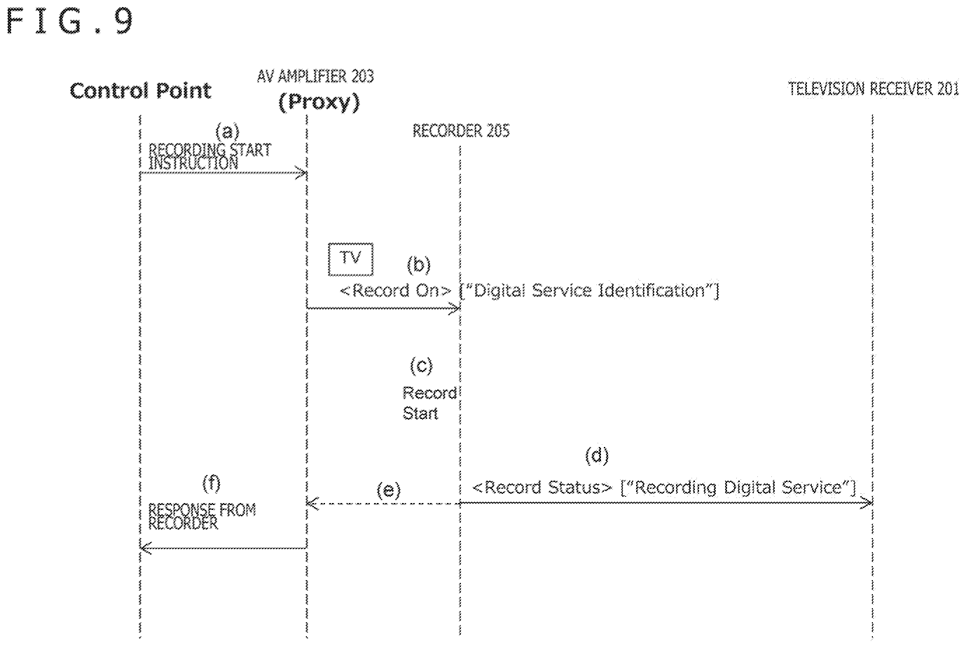

FIG. 9 illustrates a sequence diagram in a case where the recording start operation of a predetermined receiving channel is performed by the user and the command of <Record On> or a command equivalent to this command is transmitted from the control point to the AV amplifier 203.

(a) The control point transmits the command of <Record On> or a command equivalent to this command to the AV amplifier 203 and instructs the recording of the predetermined receiving channel to be started. In this command, the receiving channel information (identification information regarding digital service) is included.

(b) The AV amplifier 203 transmits a CEC frame containing the command of <Record On> to the recorder 205 through the CEC bus. In this case, the AV amplifier 203 is not the device capable of transmitting the command of <Record On> and generates a CEC frame (CEC frame in which the impersonation is performed) in which the transmitter address is rewritten to “TV” that is an address of the device capable of transmitting the command of <Record On>, and the AV amplifier 203 transmits the CEC frame (see FIG. 8(b)).

(c) The recorder 205 that receives the CEC frame containing the command of <Record On> sets the receiving channel of the tuner on the basis of the receiving channel information and starts the recording. (d) Further, the recorder 205 transmits a CEC frame containing the recording status information as a response to the television receiver 201 through the CEC bus. In this case, the television receiver 201 is the impersonated device and receives the response with which television receiver 201 has no concern and neglects the response.

(e) In this case, the AV amplifier 203 monitors the CEC bus, confirms the response from the recorder 205 to the television receiver 201, and receives the response as the response to the AV amplifier 203. (f) Further, the AV amplifier 203 transmits the information regarding the response to the control point. The control point can display the start of the recording on the display on the basis of the information.

As described above, in the home network system 10 illustrated in FIG. 1, in a case where the AV amplifier 203 serving as a main controller is a device incapable of transmitting a command that is received from the control point 301 or control point 302, the AV amplifier 203 generates a CEC frame in which the transmitter address is rewritten to an address of the device capable of transmitting the command, that is, the CEC frame in which the impersonation is performed and sends the rewritten CEC frame to the CEC bus (CEC line).

Therefore, even if the AV amplifier 203 is a device incapable of transmitting a command received from the IP network, the AV amplifier 203 can preferably transmit the command to a corresponding device in the HDMI network. Accordingly, all the devices within the HDMI network can be controlled from the AV amplifier 203 serving as a system controller.

### 2. Modification Example

Note that, according to the above-described embodiment, an example in which the AV amplifier 203 within the HDMI network has the proxy function and serves as the main controller has been described. However, a case in which other devices within the HDMI network each have the proxy function and serve as the main controller is also considered, and as a matter of course, the present invention is similarly applicable to the above case.

In addition, according to the above-described embodiment, an example in which a first network is the IP network and a second network is the HDMI network has been described. However, each of the networks is not limited thereto. Note, however, that the second network is a network dealing with a command that limits the transmitter.

In addition, the present technology may also be configured as below.

(1) A proxy device including:

a command reception section receiving a command transmitted from a device on a first network; and

a command sending section adding transmitter information and receiver information to the received command and sending the command to a command transmission path of a second network,

in which the command sending section rewrites the transmitter information added to the command from information regarding the proxy device to information regarding a device capable of transmitting the command when the proxy device is a device incapable of transmitting the received command.

(2) The proxy device according to (1), further including:

a response determination section determining a response sent corresponding to the command to the command transmission path to be a response to the proxy device on the basis of the rewritten transmitter information when the rewrite of the transmitter information is performed in the command sending section.

(3) The proxy device according to (1) or (2), further including:

a database in which a command is made to correspond to a device capable of transmitting the command,

in which the command sending section obtains information regarding a device capable of transmitting the received command on the basis of the database.

(4) The proxy device according to any of (1) to (3),

in which the first network is an IP network,

the second network is an HDMI network, and

the command transmission path is a CEC bus.

(5) A processing method of a proxy device, including:

a command reception step of receiving a command transmitted from a device on a first network; and

a command sending step of adding transmitter information and receiver information to the received command and sending the command to a command transmission path of a second network,

in which, at the command sending step, the transmitter information added to the command is rewritten from information regarding the proxy device to information regarding a device capable of transmitting the command when the proxy device is a device incapable of transmitting the received command.

(6) A network apparatus including:

a plurality of devices that are connected to one another,

in which at least one device of the plurality of devices has a proxy function,

the device having the proxy function includes
a command reception section receiving a command transmitted from a device on an external network, and
a command sending section adding transmitter information and receiver information to the received command and sending the command to a command transmission path, and

the command sending section rewrites the transmitter information added to the command from information regarding the device having the proxy function to information regarding a device capable of transmitting the command when the device having the proxy function is a device incapable of transmitting the received command.

### REFERENCE SIGNS LIST

10 . . . Home network system
20 . . . HDMI network
30 . . . IP network
201 . . . Television receiver
202 . . . BD player
203 . . . AV amplifier
204 . . . Game console
205 . . . Recorder
301, 302 . . . Control point
303 . . . Router/switch

1. A proxy device comprising:
a command reception section receiving a command transmitted from a device on a first network; and
a command sending section adding transmitter information and receiver information to the received command and sending the command to a command transmission path of a second network,
wherein the command sending section rewrites the transmitter information added to the command from information regarding the proxy device to information regarding a device capable of transmitting the command when the proxy device is a device incapable of transmitting the received command.

2. The proxy device according to claim 1, further comprising:
a response determination section determining a response sent corresponding to the command to the command transmission path to be a response to the proxy device on a basis of the rewritten transmitter information when the rewrite of the transmitter information is performed in the command sending section.

3. The proxy device according to claim 1, further comprising:
a database in which a command is made to correspond to a device capable of transmitting the command,
wherein the command sending section obtains information regarding a device capable of transmitting the received command on the basis of the database.

4. The proxy device according to claim 1,
wherein the first network is an IP network,
the second network is an HDMI network, and
the command transmission path is a CEC bus.

5. A processing method of a proxy device, comprising:
a command reception step of receiving a command transmitted from a device on a first network; and
a command sending step of adding transmitter information and receiver information to the received command and sending the command to a command transmission path of a second network,
wherein, at the command sending step, the transmitter information added to the command is rewritten from information regarding the proxy device to information regarding a device capable of transmitting the command when the proxy device is a device incapable of transmitting the received command.

6. A network apparatus comprising:
a plurality of devices that are connected to one another,
wherein at least one device of the plurality of devices has a proxy function,
the device having the proxy function includes
a command reception section receiving a command transmitted from a device on an external network, and
a command sending section adding transmitter information and receiver information to the received command and sending the command to a command transmission path, and
the command sending section rewrites the transmitter information added to the command from information regarding the device having the proxy function to information regarding a device capable of transmitting the command when the device having the proxy function is a device incapable of transmitting the received command.
